(19) United States
(12) Patent Application Publication
(10) Pub. No.: US 2006/0072626 A1
(43) Pub. Date: Apr. 6, 2006

(54) Data synchronization in a telecommunication management network

(75) Inventors: Randall K. Hands, Wheaton, IL (US); Bing Leng, Naperville, IL (US); Manoj K. Mahapatra, Aurora, IL (US); James R. Stuhlmacher, Wheaton, IL (US)

Correspondence Address: DUFT BORNSEN & FISHMAN, LLP, 1526 SPRUCE STREET, SUITE 302, BOULDER, CO, 80302, US

(73) Assignee: Lucent Technologies Inc., Murray Hill, NJ (US)

(21) Appl. No.: 10/952,978

(22) Filed: Sep. 29, 2004

(51) Int. Cl. H04J 3/06

(52) U.S. Cl. 370/503; 370/350

(57) ABSTRACT

Systems, methods, and software are disclosed for synchronizing data among network elements of a telecommunication management network. In a data synchronization system, a mapping system receives a first data set from a first network element and receives a second data set from a second network element. The mapping system processes the first data set to identify a first object, and processes the first object based on mapping rules to identify an associated second object in the second data set, and map the first object and the second object. A comparison system then processes the first object and the second object as mapped to identify differences between the objects, and generates information indicating the differences. An alignment system processes the first object and the information indicating the differences to generate new object data used to adjust the first object stored in the first network element.

### BACKGROUND OF THE INVENTION

1. Field of the Invention

The invention is related to the field of telecommunication management networks, and in particular, to systems, methods, and software for synchronizing data among network elements of a telecommunication management network.

2. Statement of the Problem

In telecommunication management networks, the network elements (such as Operation Management Controllers (OMC), Radio Network Controllers (RNC), Base Transceiver Stations (BTS), etc) may each store network management data. Network management data (referred to herein as “data”) comprises any data or information for managing or controlling a telecommunication management network. Data stored in one network element may also be stored in multiple other network elements. One issue facing network operators is maintaining consistency of data that is stored in multiple network elements.

The data stored in an individual network element may be changed for various reasons. For instance, a network operator may change the data in the network element through a local interface on the network element. Also, a crash or failure in the network element may change the data in the network element. When data is changed in one or more network elements such that the data is no longer consistent over the network, then network operators face the challenge of synchronizing the data once again.

One solution for synchronizing data is using a master database that stores a master copy of network management data for the network. If data in a network element has changed, then the data stored in the master database is used to adjust the data in the network element so that the data is once again synchronized over the network. The synchronization generally comprises a straight-forward data copy from the master database to the network element.

However, the master database solution becomes very complex and less effective when the data stored in one network element does not directly correspond with data stored in other network elements. For example, in a 3G wireless network, regulatory and standards agencies require the interoperability of network elements for call processing, but do not require interoperability for network management. Thus, network management data stored in network elements may not correspond. For instance, network elements can be supplied from different vendors, and network elements from each vendor generally have their own network management data (referred to herein as distribution of network management data). Also, to support telecommunication services, such as call processing and call handover, the network elements from various vendors are linked together and the relationships are defined across the network elements (referred to herein as duplication of network management data). Further, each vendor may choose its own data model, which means that the same data duplicated across the network elements may have different representations (referred to herein as transformation of network management data).

A problem remains for network operators to synchronize network management data among network elements when the data stored in the network elements does not directly correspond because of distribution, duplication, transformation, or other reasons.

### SUMMARY OF THE SOLUTION

The invention solves the above and other related problems by defining mapping rules for identifying associated objects in network management data stored in different network elements of a telecommunication management network. The mapping rules are also used for mapping the objects to one another by mapping attributes of the objects to one another. With the objects mapped, differences between the associated objects may be identified. One or more of the objects may then be adjusted based on the differences so that the data is synchronized among the network elements in the telecommunication management network. Advantageously, network operators are able to synchronize network management data in a telecommunication management network even if the data stored in one network element does not directly correspond with data in other network elements. More particularly, network operators are able to synchronize network management data in a telecommunication management network even if the data stored in the network elements is distributed, duplicated, or transformed.

One embodiment of the invention comprises a data synchronization system for a telecommunication management network. The data synchronization system includes a mapping system, a comparison system, an alignment system, and a command system. In operation, the mapping system receives a first data set from a first network element storing network management data. The mapping system also receives a second data set from a second network element storing network management data. The first data set from the first network element does not directly correspond with the second data set from the second network element. The mapping system processes the first data set to identify a first object in the first data set. The mapping system then processes the first object of the first data set based on mapping rules to identify a second object in the second data set that is associated with the first object. The mapping system also processes the first object and the second object based on the mapping rules to map the first object to the second object.

With the first object and the second object mapped to one another, the comparison system processes the first object and its associated second object to identify differences between the objects. The comparison system generates information indicating the differences between the first object and the second object, and transmits the information to the alignment system.

The alignment system receives the information indicating the differences between the first object and the second object. The alignment system also receives the first object. The alignment system processes the first object and the information indicating the differences between the first object and the second object to generate new object data. The alignment system transmits the new object data to the command system. The command system generates commands based on the new object data to adjust the first object stored in the first network element, and transmits the commands to the first network element.

The invention may include other exemplary embodiments described below.

### DESCRIPTION OF THE DRAWINGS

The same reference number represents the same element on all drawings.

FIG. 1 illustrates a telecommunication management network in the prior art.

FIG. 2 illustrates a data synchronization system for a telecommunication management network in an exemplary embodiment of the invention.

FIG. 3 is a flow chart illustrating a method of synchronizing data in a telecommunication management network in an exemplary embodiment of the invention.

FIG. 4 is a flow chart illustrating additional steps of the method of FIG. 3 in another exemplary embodiment of the invention.

FIG. 5 illustrates a computer system for synchronizing data in a telecommunication management network in an exemplary embodiment of the invention.

FIG. 6 illustrates a data synchronization system for a telecommunication management network in another exemplary embodiment of the invention.

FIG. 7 illustrates mapping SNM data and RNC data using the mapping rules in an exemplary embodiment of the invention.

FIG. 8 illustrates mapping associated objects using the mapping rules in an exemplary embodiment of the invention.

### DETAILED DESCRIPTION OF THE INVENTION

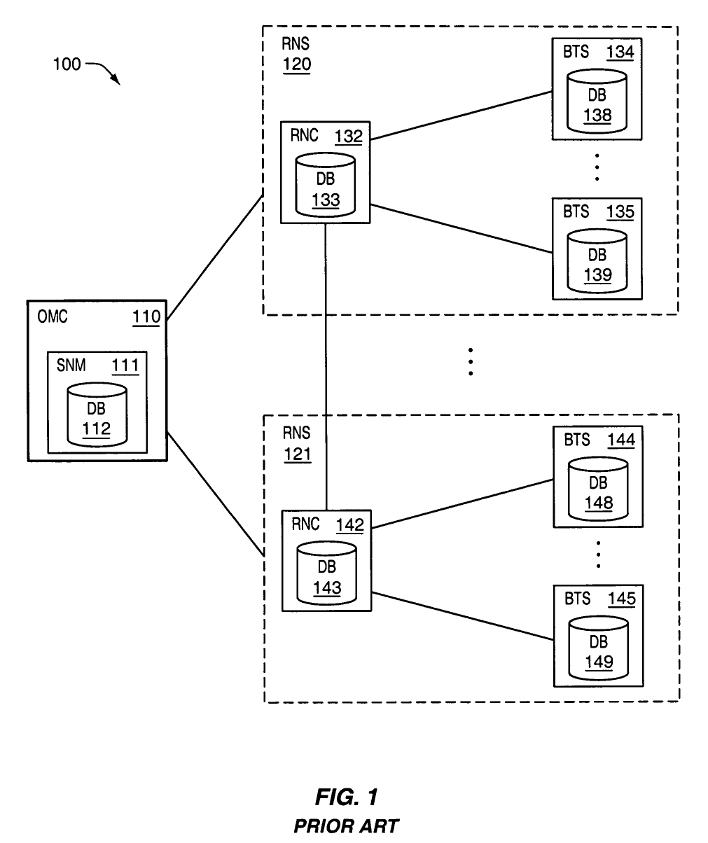

Prior Art Telecommunication Management Network—FIG. 1

FIG. 1 illustrates a telecommunication management network 100 in the prior art. Telecommunication management network 100 comprises an operation management center (OMC) 110 and a plurality of Radio Network Systems (RNS) 120-121. Telecommunication management network 100 could include multiple OMCs. RNS 120 includes Radio Network Controller (RNC) 132 and a plurality of Base Transceiver Stations (BTS) 134-135. RNS 121 includes RNC 142 and a plurality of BTSs 144-145. OMC 110 connects to RNS 120 and RNS 121 and the elements within. Within RNS 120, RNC 132 connects to BTSs 134-135 and RNC 142. Within RNS 121, RNC 142 connects to BTSs 144-145. Some of the terms used to describe telecommunication management network 100 may be understood by those skilled in the art to refer to a UMTS network, but telecommunication management network 100 may comprise a GSM network, a CDMA network, or any other type of telecommunication management network.

OMC 110 includes Subnetwork Management (SNM) 111 that includes a database 112. RNC 132 includes database 133, and RNC 142 includes database 143. BTSs 134-135 include databases 138-139 respectively. BTSs 144-145 include databases 148-149 respectively. Each of the databases is configured to store network management data.

One issue facing network operators is maintaining consistency of the network management data that is stored in the databases. The data stored in a database in a network element may be changed for various reasons. For instance, a network operator may change the data stored in database 133 in RNC 132 through a local interface on RNC 132. Also, a crash or failure in RNC 132 may change the data stored in database 133. When data is changed in one or more network elements such that the data is no longer consistent over telecommunication management network 100, it is a problem for network operators to synchronize the data once again.

The problem is magnified when the data stored in one database does not directly correspond with data stored in other databases. The data stored in the databases may not directly correspond for various reasons. For instance, network elements can be supplied from different vendors, and network elements from each vendor generally have their own network management data (referred to herein as distribution of network management data). Also, to support telecommunication services, such as call processing and call handover, the network elements from various vendors are linked together and the relationships are defined across the network elements (referred to herein as duplication of network management data). Further, each vendor may choose its own data model, which means that the same data duplicated across the network elements may have different representations (referred to herein as transformation of network management data).

A problem remains for network operators to synchronize data among network elements when the data stored in the network elements does not directly correspond for at least the reasons described above.

### DESCRIPTION OF THE INVENTION

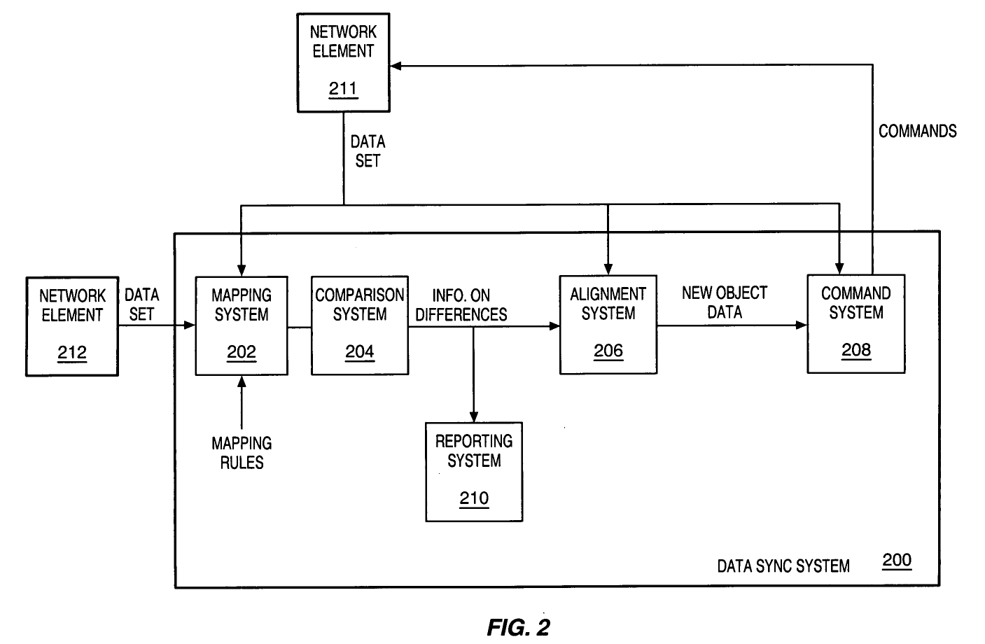

FIGS. 2-8 and the following description depict specific exemplary embodiments of the invention to teach those skilled in the art how to make and use the best mode of the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 2 illustrates a data synchronization system 200 for a telecommunication management network in an exemplary embodiment of the invention. Data synchronization system 200 is part of or is connected to the telecommunication management network (not shown), such as a UMTS network, a GSM network, a CDMA network, or another type of telecommunication management network. Data synchronization system 200 includes a mapping system 202, a comparison system 204, an alignment system 206, a command system 208, and a reporting system 210. Mapping system 202 is connected to comparison system 204. Comparison system 204 is connected to alignment system 206 and reporting system 210. Alignment system 206 is connected to command system 208. Data synchronization system 200 may include other components, devices, or systems not shown in FIG. 2.

Mapping system 202 is also connected to a network element 211 and a network element 212. A network element comprises any operational component, device, or system in a telecommunication management network that stores network management data. Examples of a network element include Operation Management Controllers (OMC), Radio Network Controllers (RNC), and Base Transceiver Stations (BTS). Network management data (referred to herein as “data”) comprises any data or information for managing or controlling a telecommunication management network. Assume that network element 211 and network element 212 each store network management data that does not directly correspond with each other.

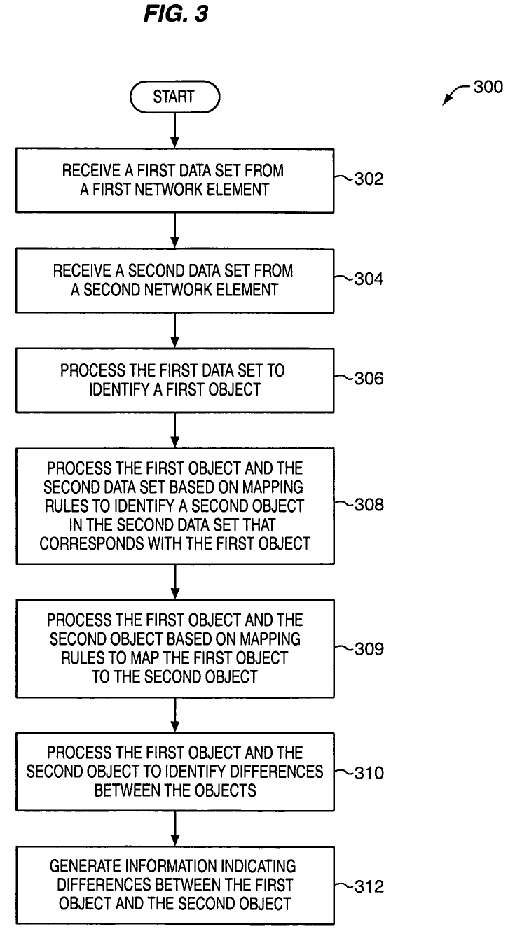

FIG. 3 is a flow chart illustrating a method 300 of synchronizing data in a telecommunication management network in an exemplary embodiment of the invention. Method 300 is described as if being implemented using data synchronization system 200. In step 302, mapping system 202 (see FIG. 2) receives a first data set from network element 211. A data set comprises any collection of network management data. In step 304, mapping system 202 receives a second data set from network element 212. The first data set from network element 211 does not directly correspond with the second data set from network element 212. To not directly correspond, the attributes of the first data set does not have one-to-one correspondence with the attributes of the second data set. For instance, one or both of the first data set and the second data set may have been distributed, duplicated, or transformed.

In step 306, mapping system 202 processes the first data set to identify an object in the first data set. An object comprises any managed data structure. In step 308, mapping system 202 processes the second data set and the object of the first data set based on mapping rules to identify an object in the second data set that is associated with the object of the first data set. In this embodiment, method 300 may further include the step of generating the mapping rules. The mapping rules may be written in a declarative language, such as extensible markup language (XML). In step 309, mapping system 202 processes the object of the first data set and the object of the second data set based on the mapping rules to map the first object to the second object. For instance, mapping system 202 may use the mapping rules to map attributes, fields, values, etc. of the first object to the second object.

In step 310, comparison system 204 (see FIG. 2) processes the object of the first data set and the object of the second data set as mapped to identify differences between the objects. In step 312, the comparison system 204 generates information indicating the differences between the objects. Comparison system 204 transmits the information indicating the differences between the objects to alignment system 206.

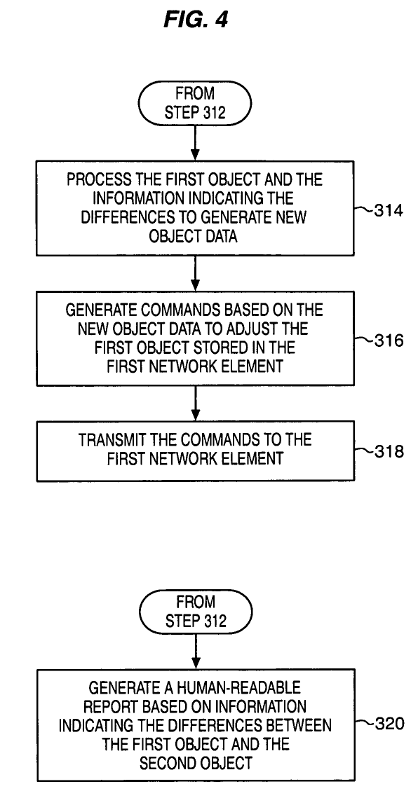

Alignment system 206 receives the information indicating the differences between the objects. Alignment system 206 also receives the object of the first data set. FIG. 4 is a flow chart illustrating additional steps of method 300 in another exemplary embodiment of the invention. In step 314, alignment system 206 processes the object of the first data set and the information indicating the differences between the objects to generate new object data. The new object data reflects the results of aligning the objects. Alignment system 206 transmits the new object data to command system 208. In step 316, command system 208 generates commands based on the new object data to adjust the object stored in network element 211. The commands may comprise Command Line Interface (CLI) commands or other commands. In step 318, command system 208 transmits the commands to network element 211. Responsive to the commands, network element 211 adjusts the object stored in network element 211. After adjusting the object stored in network element 211, the associated objects in network element 211 and network element 212 should be synchronized.

In step 320, reporting system 210 receives the information indicating the differences between the objects. Reporting system 210 generates a human-readable report based on the information for review by network operators. The network operators may use the report to instruct alignment system 206 how to align the objects or which objects to adjust.

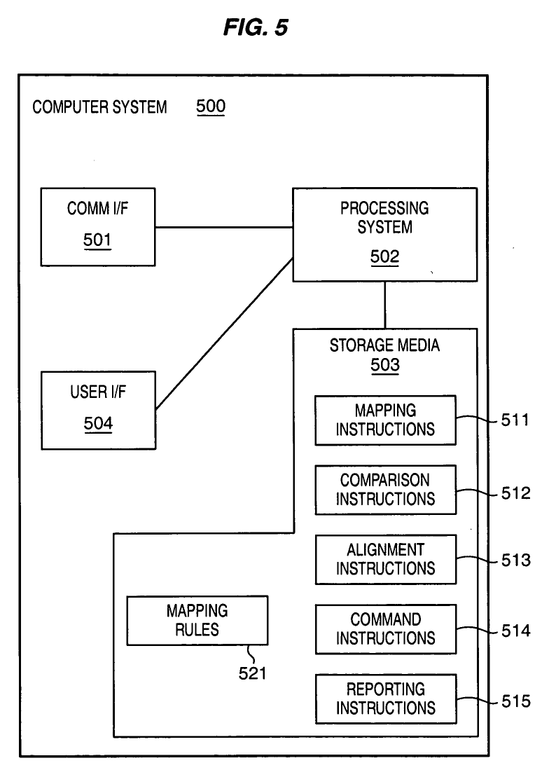

FIG. 5 illustrates a computer system 500 for synchronizing data in a telecommunication management network in an exemplary embodiment of the invention. Computer system 500 includes a communication interface 501, a processing system 502, storage media 503, and a user interface 504. Storage media 503 stores mapping instructions 511, comparison instructions 512, alignment instructions 513, command instructions 514, reporting instructions 515, and mapping rules 521. Processing system 502 is linked to communication interface 501, storage media 503, and user interface 504. Computer system 500 could be comprised of a programmed general-purpose computer, such as a desktop computer or a laptop computer. Processing system 502 could comprise a computer microprocessor, logic circuit, or some other processing device. Storage media 503 could comprise a disk, tape, CD, integrated circuit, server, or some other memory device. Storage media 503 may be distributed among multiple memory devices. User interface 504 could comprise a display, keyboard, mouse, voice recognition interface, graphical display, touch-screen, or some other type of user device.

In operation, processing system 502 executes mapping instructions 511, comparison instructions 512, alignment instructions 513, command instructions 514, and reporting instructions 515 to perform method 300 (see FIGS. 3-4). For instance, processing system 502 may execute mapping instructions 511 to perform at least steps 302, 304, 306, 308 and 309 of FIG. 3. In executing mapping instructions 511, processing system 502 also accesses mapping rules 521 stored in storage media 503. Processing system 502 may execute comparison instructions 512 to perform at least steps 310 and 312 of FIG. 3. Processing system 502 may execute alignment instructions 513 to perform at least step 314 in FIG. 4. Processing system 502 may execute command instructions 514 to perform at least steps 316 and 318 in FIG. 4. Processing system 502 may execute reporting instructions 515 to perform at least step 320 in FIG. 4. Mapping instructions 511, comparison instructions 512, alignment instructions 513, command instructions 514, and reporting instructions 515 may be generated and written in an interpretive language, such as extensible stylesheet language transformations (XSLT).

The mapping rules referenced in the above description may be generated or defined in a variety of ways. The following will list particular mapping rules as an illustrative example, and the invention is not limited to these mapping rules. Given an object in one data set, at least one of the mapping rules identifies an associated object in another data set. For instance, this mapping rule is used to perform step 308 in FIG. 3. Once associated objects are located, other mapping rules are used to map the associated objects to one another.

At least one of the mapping rules defines direct mapping between corresponding attributes of objects, meaning that the attributes of the two objects directly correspond with one another. More particularly, at least one of the mapping rules defines direct mapping between two objects having attribute names that are the same. For instance, a direct mapping rule in XML may read: <AttrMap top=“attributename” bottom=“attributename”/>.

At least one of the mapping rules defines indirect mapping between attributes of objects. More particularly, if an attribute of a first object does not have a corresponding attribute in a second object, then at least one of the mapping rules defines how to locate a third object that includes the attribute. For instance, mapping rules that define how to locate the object in XML may read:

```
<References>
  <Ref from=“object 1” to=“object 3” via=“object 2”/>
  <Ref from=“object 1” to=“object 2” ref=“reference name 1”/>
  <Ref from=“object 2” to=“object 3” ref=“reference name 2”/>
</References>
```

These rules allow object 1 to reference object 3 through object 2 in order to identify an attribute for mapping.

At least one of the mapping rules defines mapping from one attribute of an object to multiple attributes of another object.

At least one of the mapping rules defines mapping between attribute values of a different type. More particularly, if two corresponding attributes have values that cannot be directly compared, then at least one of the mapping rules defines how to compare attributes of a different type.

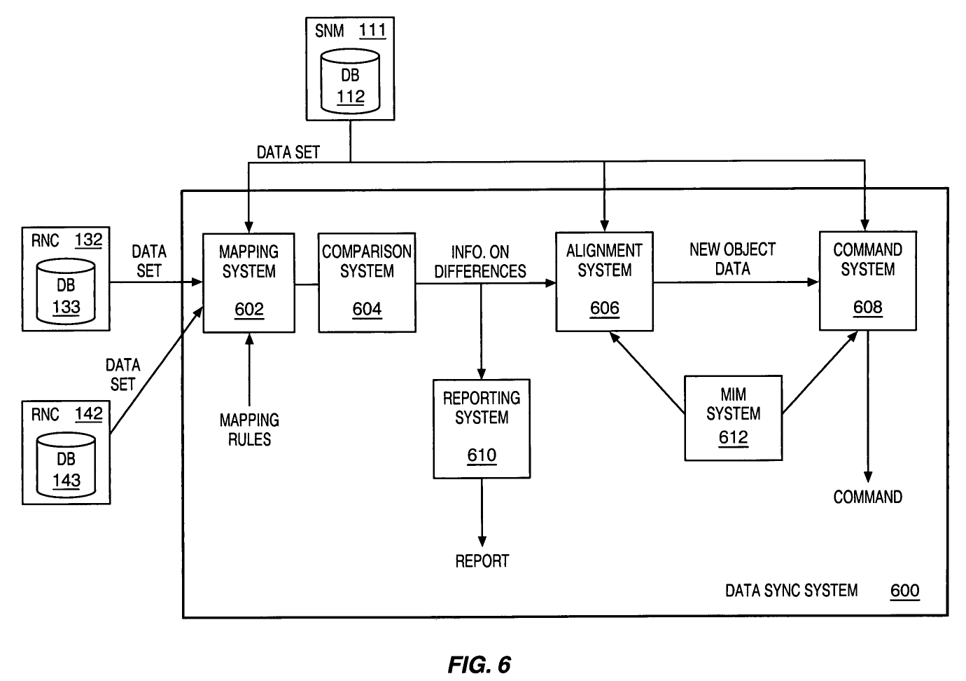

FIG. 6 illustrates a data synchronization system 600 for a telecommunication management network in an exemplary embodiment of the invention. Data synchronization system 600 is part of or is connected to the telecommunication management network 100 for the sake of illustration. Data synchronization system 600 includes a mapping system 602, a comparison system 604, an alignment system 606, a command system 608, a reporting system 610, and a Management Information Model (MIM) system 612. Mapping system 602 is connected to comparison system 604, SNM 111, RNC 132, and RNC 142. Comparison system 604 is connected to alignment system 606 and reporting system 610. Alignment system 606 is connected to command system 608 and MIM system 612. Command system 608 is also connected to MIM system 612. Data synchronization system 600 may include other components, devices, or systems not shown in FIG. 6.

As shown in FIGS. 1 and 6, SNM 111 includes database 112, RNC 132 includes database 133, and RNC 142 includes database 143. Each database 112, 133, and 143 stores network management data for telecommunication management network 100. The network management data is modeled in managed objects. The modeling of the managed objects involves inheritance and containment relationships among managed objects, attributes (i.e., properties) of the managed objects, attribute management (such as access interface, read-only, etc.), associations between the managed objects (pointers), relations among the managed objects in different network elements for a given physical entity (a link), Distinguished Name (DN) naming rules defining the correspondence of objects from different network elements, and behavior of the managed objects.

Assume for this embodiment that the network management data stored in databases 112, 133, and 143 has been distributed, duplicated, transformed, or otherwise altered so that there is not one-to-one correlation between similar data. Periodically, such as daily, weekly, or on command, SNM 111, RNC 132, and RNC 142 each transmit a data set to mapping system 602.

One problem with processing the data sets from SNM 111, RNC 132, and RNC 142 when the data sets do not have one-to-one correlation is identifying objects of the data sets that are associated or supposed to be associated with one another. To overcome the problem in this embodiment, mapping rules have been generated to identify associated objects in the data sets. To achieve a greater level of flexibility and extensibility, the data sets, the model, and the mapping rules are represented declaratively using XML, which is a simple, declarative, and standard way to interchange structured textual data across applications as well as across hardware platforms and operating systems.

Mapping system 602 processes the data set from SNM 111 to identify an object in that data set. Mapping system 602 processes the object of the data set from SNM 111 based on mapping rules to identify an object in the data set from RNC 132 and an associated object in the data set from RNC 142. A natural way to process the XML-based mapping rules is through an interpretive engine embodied in mapping system 602. The function and operation of mapping system 602 is defined by XSLT instructions. XSLT itself is XML and is primarily designed for transforming one XML document into another.

When associated objects are identified, another problem is mapping the objects to one another. To map the objects, mapping system 602 processes the objects based on the mapping rules to map attributes, fields, values, etc. of objects to one another. Table I illustrates mapping rules in this embodiment of the invention.

TABLE I
Mapping rule types

| Type | Description |
|---|---|
| Class mapping | The mappings are done class by class. A class mapping consists |
| | of one or more attribute/sequence mapping(s). |
| Attribute mapping | For each class, attributes are compared one by one. Attribute |
| | mapping supports simple attributes such as an attribute in its |
| | class, a field in a non-sequence structure, or a fully qualified |
| | attribute in another class. |
| Sequence mapping | Sequence mapping supports sequence attributes. It consists of |
| | zero or more field mapping(s). A sequence can be an attribute in |
| | its class or a fully qualified attribute in another class. |
| Field mapping | Field mapping is to identify the fields in a structure that are |
| | mapped. It consists of zero or more value mapping(s). Note: one |
| | of the mapping fields can be empty because one of the sequences |
| | may be of a simple type. |
| Value mapping | Value mapping specifies the mapping of data values for an |
| | attribute. |
| Reference | References are to show how to get from one class to another. |
| | They can be chained together when there is more than one hop |
| | between the classes. A conflict resolution can be defined for the |
| | situation where more than one reference is applicable. |
| Where/topWhere | Where/topWhere clause can be defined in many of the above |
| clause | mappings for filtering out the unwanted entities such as |
| | instances, attributes, or structures. |

Direct mappings are the mappings between two compatible network elements. As shown in Table I, the mapping rules are designed to capture the mappings between classes, attributes, sequences, fields, and values. The mappings are defined in such a way so that the object-oriented nature in the data model can be reflected. The top-level class mapping captures the one-to-one relationship between objects in different domains. Once a mapping between two objects is established, the second-level attribute mapping can then be applied between two attributes relative to those objects. Based on the type of the attributes, the corresponding sequence/field/value mapping may be applied.

Irregular mappings are the mappings between two incompatible network elements. The complexity of the domain model leads to irregular mappings. The mapping rules are designed rich enough to represent this type of mapping.

With associated objects identified and mapped to one another, comparison system 604 processes the object from SNM 111 and its associated object from RNC 132 to identify differences between the objects. Comparison system 604 generates information indicating the differences between the objects, and transmits the information indicating the differences between the objects to alignment system 606 and reporting system 610.

For instance, assume that the data set from SNM 111 is referred to as ‘top’ and the data set from RNC 132 is referred to as ‘bottom’ (see mapping rules that follow). For each object in the data set from RNC 132, mapping system 602 identifies a class mapping rule and a DN mapping rule to find the corresponding object in the data set from SNM 111. Comparison system 604 performs the comparison between the constructs (attributes, structures, sequence of structures, sequence of basic types, values, etc.) within the objects based on the corresponding mapping rules. During the comparison, if a counterpart entity cannot be found then it is marked as missing and if both entities exist but the corresponding values are different then a mismatch is found. Both the missing entity and the mismatch are reported. When comparison system 604 is done with the data set from SNM 111, comparison system 604 may reverse the sides so that the data set from SNM 111 is referred to as ‘bottom’ and the data set from RNC 132 is referred to as ‘top’, and the above steps are repeated.

Reporting system 610 receives the information indicating the differences between the objects and generates a human-readable report of the information. The human-readable report is for the network operators to review. Based on the report, the network operators can make an educated decision on which data in which network element is corrupt. For instance, the network operators may know that RNC 132 had an earlier failure and that the data stored in database 133 needs to be adjusted. The network operators may then instruct alignment system 606 which data needs to be adjusted.

Alignment system 606 receives the information indicating the differences between the objects, the objects themselves, and possibly an instruction from the network operators. For each missing entity (either an object or a structure) in the data set from RNC 132, alignment system 604 removes the corresponding entity in the object of the SNM 111. For each missing entity in the object of SNM 111, alignment system 604 adds the missing entity in the object of SNM 111. Each value mismatch, alignment system 604 aligns the value of the object of SNM 111 with the value of the object of RNC 132. When adding a missing entity or aligning value, alignment system 606 receives a template of the object from MIM system 612. To construct a proper object according to the model used by a particular network element, MIM system 612 maintains a template for each different data model that alignment system 606 uses to re-construct a missing entity.

Using this alignment process, alignment system 606 generates new object data that reflects the result of the alignment process. Alignment system transmits the new object data to command system 608. Command system 608 generates a set of Command Line Interface (CLI) commands to correct data inconsistencies. Command system 608 transmits the CLI commands to SNM 111. Responsive to the commands, SNM 111 adjusts the object stored in database 112. After adjusting the object stored in database 112, the associated objects stored in database 112, database 133, and database 143 should be synchronized.

The following data shows an example of the mapping rules in this embodiment of the invention.

```
  <Rules name=“RNC”>
    <Mappings top=“SNM” bottom=“RNC”>
      <ClassMap top=“SNM.UtranCell” bottom=“RNC.LCell”>
        <AttrMap top=“userLabel” bottom=“userLabel” level=“3”/>
        <AttrMap top=“lac” bottom=“RNC.LA.locationAreaCode”/>
        <AttrMap top=“rac” bottom=“RNC.RA.routingAreaCode”/>
        <SeqMap top=“outgoingGsmIsDaho” bottom=“outFddToGsmCellsDaho”
          topKey=“refCell” bottomKey=“.” dnTypeKey=“GsmExtCell”>
          <FieldMap top=“refCell” dnType=“GsmExtCell”/>
          <FieldMap top=“relationType”
          bottom=“byIndex:outFddToGsmCellsDahoPri”>
          <ValueMap top=“isDaho1” bottom=“1”/>
          <ValueMap top=“isDaho2” bottom=“2”/>
          <ValueMap top=“isDaho3” bottom=“3”/>
        </FieldMap>
      </SeqMap>
    </ClassMap>
    <ClassMap top=“SNM.UtranCell” bottom=“RNC.FddExtCell”
      topWhere=“$topMOI/Attr[@name=‘incomingHO’]
            //StructEntry[@name=‘refExtCell’]=$bottomDN
          or
          contains(map:getAllRns($topMOI/Attr[@name=‘outgoingGsmIsDaho’]
          //StructEntry[@name=‘peerRncList’]), map:getRns($bottomDN))”>
      <SeqMap top=“uraSeq” bottom=“RNC.URA.uRAC”
        where=“string($topItem/Struct/StructEntry[@name=‘uRAPreferred’])
          = ‘true’”>
        <FieldMap top=“uRARef”/>
      </SeqMap>
      <SeqMap top=“incomingHO” bottom=“inAdjCells”
      topWhere=“string($topItem/Struct/StructEntry[@name = ‘refExtCell’])
          = $bottomDN” topKey=“refCell” bottomKey=“.” dnTypeKey=“Cell”>
          <FieldMap top=“refCell” dnType=“Cell”/>
          <FieldMap top=“refExtCell” bottom=“dn:”/>
        </SeqMap>
      </ClassMap>
      <ClassMap top=“SNM.ExtRncFunction” bottom=“RNC.PRNC”
        topWhere=“$G-topDoc/MOIList/MOI[@class=‘IurLink’ and
            contains(@fdn, concat(‘Rns=’, $G-bottomNEinst, ‘,’))
          ]/Attr[@name=‘associatedFunctionId’]=$topMOI/@fdn
          or contains($G-topDoc/MOIList/MOI[@class=‘IurLink’ and
              contains(@fdn, $topMOI/@fdn)
              ]/Attr[@name=‘associatedFunctionId’],
              concat(‘Rns=’, $G-bottomNEinst, ‘,’))”>
        <AttrMap top=“rncId” bottom=“rNCId”/>
        <SeqMap top=“mcc” bottom=“mCC”/>
        <SeqMap top=“mnc” bottom=“mNC”/>
      </ClassMap>
    </Mappings>
    <References>
      <Ref from=“RNC.LCell” to=“RNC.LA” via=“RNC.RA”/>
      <Ref from=“RNC.LCell” to=“RNC.RA” ref=“lCellRefRA”/>
      <Ref from=“RNC.RA” to=“RNC.LA” ref=“rARefLa”/>
      <Ref from=“RNC.IuR” to=“RNC.SS7LinkSet” ref=“mtp3bRrefSS7” type=“rnsap”/>
      <Ref from=“RNC.IuR” to=“RNC.SS7LinkSet” ref=“mtp3bRrefSS7ALCAP”
type=“alcap”/>
    </References>
  </Rules>
```

The following two examples illustrate how the mapping rules are used to identify corresponding objects and map the objects to one another to compare the objects.

### EXAMPLE 1

Assume for this example that SNM data and RNC data have been received. For the SNM data, a first object is identified called “ExtRncFunction”. Mapping rules are defined and used to identify the associated object in the RNC data. The following mapping rule is used to identify the associated object “PRNC” in the RNC data:

```
<ClassMap top=“SNM.ExtRncFunction” bottom=“RNC.PRNC”
  topWhere=“$G-topDoc/MOIList/MOI[@class=‘IurLink’ and
      contains(@fdn, concat(‘Rns=’, $G-bottomNEinst, ‘,’))
    ]/Attr[@name=‘associatedFunctionId’]=$topMOI/@fdn
    or contains($G-topDoc/MOIList/MOI[@class=‘IurLink’ and
        contains(@fdn, $topMOI/@fdn)
        ]/Attr[@name=‘associatedFunctionId’],
        concat(‘Rns=’, $G-bottomNEinst, ‘,’))”>
    <AttrMap top=“rncId” bottom=“rNCId”/>
    <SeqMap top=“mcc” bottom=“mCC”/>
    <SeqMap top=“mnc” bottom=“mNC”/>
</ClassMap>
```

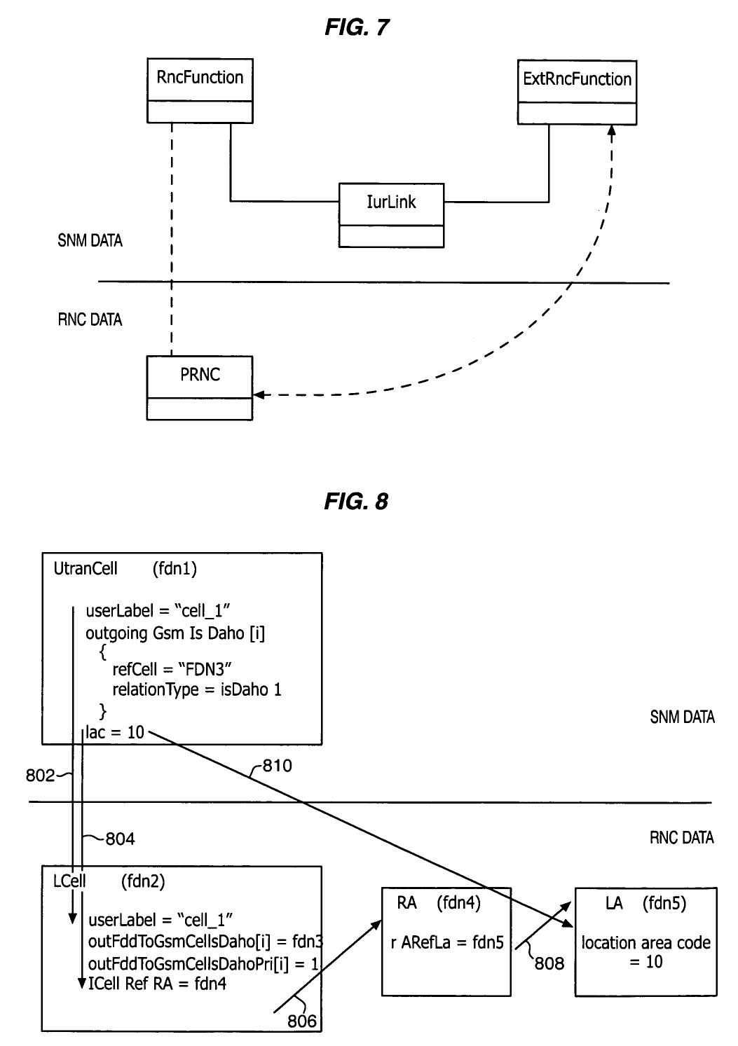

FIG. 7 illustrates mapping SNM data and RNC data using the mapping rules in an exemplary embodiment of the invention. Assuming that there is no direct correlation between object “ExtRncFunction” and object “PRNC”, the “topWhere” clause in the mapping rules specifies the indirect associations through which object “PRNC” could be found. For a given object “ExtRncFunction”, the “topWhere” clause provides for a search through the SNM data set to find object “IurLink” such that it is associated with object “ExtRncFunction” or contained under object “ExtRncFunction”. Object “IurLink” is contained under an object “RncFunction” or associated with object “RncFunction”. Then based on object “RncFunction”, the “topWhere” clause provides for a search through the RNC data set to find object “PRNC” such that these two objects have the same RNS number. If object “PRNC” is found, then it is the corresponding object for object “ExtRncFunction”.

### EXAMPLE 2

Assume again for this example that SNM data and RNC data have been received. For the SNM data, a first object is identified called “UtranCell”. For the RNC data, an object associated with object “UtranCell” is identified called “LCell”. Mapping rules are defined and used to map the objects to one another in order to compare the objects. The following mapping rules are used to map the associated objects “UtranCell” and “LCell”:

```
  <ClassMap top=“SNM.UtranCell” bottom=“RNC.LCell”>
    <AttrMap top=“userLabel” bottom=“userLabel”/>
    <AttrMap top=“lac” bottom=“RNC.LA.locationAreaCode”/>
    <SeqMap top=“outgoingGsmIsDaho”
    bottom=“outFddToGsmCellsDaho”
      topKey=“refCell” bottomKey=“.” dnTypeKey=“GsmExtCell”>
      <FieldMap top=“refCell” dnType=“GsmExtCell”/>
    <FieldMap top=“relationType”
        bottom=“byIndex:outFddToGsmCellsDahoPri”>
        <ValueMap top=“isDaho1” bottom=“1”/>
        <ValueMap top=“isDaho2” bottom=“2”/>
        <ValueMap top=“isDaho3” bottom=“3”/>
      </FieldMap>
    </SeqMap>
  </ClassMap>
<References>
  <Ref from=“RNC.LCell” to=“RNC.LA” via=“RNC.RA”/>
  <Ref from=“RNC.LCell” to=“RNC.RA” ref=“lCellRefRA”/>
  <Ref from=“RNC.RA” to=“RNC.LA” ref=“rARefLa”/>
</References>
```

FIG. 8 illustrates mapping associated objects using the mapping rules in an exemplary embodiment of the invention. A first type of mapping is direct mapping of attributes in the objects. With direct mapping, an attribute or attribute name in object “UtranCell” directly matches an attribute or attribute name in object “LCell”. In FIG. 8, object “UtranCell” includes an attribute with the attribute name “userLabel”. Similarly, object “LCell” includes an attribute with the attribute name “userLabel”. The following mapping rule directly maps the similar attributes of object “UtranCell” and object “LCell”:
<AttrMap top=“userLabel” bottom=“userLabel”/>.
   Arrow 802 represents the direct mapping.

Another type of mapping is indirect mapping. With indirect mapping, an attribute in object “UtranCell” does not directly correspond with an attribute in object “LCell”. The mapping rules define how to locate where the corresponding attribute resides. In FIG. 8, object “UtranCell” includes an attribute with attribute name “lac”. The following mapping rule defines that the corresponding attribute having the name “locationAreaCode” does not reside in object “LCell”, but rather in RNC object “LA”:
<AttrMap top=“lac” bottom=“RNC.LA.locationAreaCode”/>.

Arrow 804 represents the indirect mapping. The following mapping rules (may also be referred to as reference rules within the mapping rules) define how to locate object “LA”:

```
<References>
  <Ref from=“RNC.LCell” to=“RNC.LA” via=“RNC.RA”/>
  <Ref from=“RNC.LCell” to=“RNC.RA” ref=“lCellRefRA”/>
  <Ref from=“RNC.RA” to=“RNC.LA” ref=“rARefLa”/>
</References>
```

Rule <Ref from=“RNC.LCell” to=“RNC.LA” via=“RNC.RA”/> provides that object “LA” is found from object “LCell” through object “RA”. Rule <Ref from=“RNC.LCell” to=“RNC.RA” ref=“lCellRefRA”/> provides that object “RA” is found through object “LCell” using the pointer defined in attribute “lCellRefRA” of object “LCell”. The pointer is represented in FIG. 8 as arrow 806. Rule <Ref from=“RNC.RA” to=“RNC.LA” ref=“rARefLa”/> provides that object “LA” is found from object “RA” using the pointer defined in attribute “rARefLa” of object “RA”. The pointer is represented in FIG. 8 as arrow 808. By defining indirect mapping using mapping rules, we can traverse any numbers of pointers. By locating attribute “locationAreaCode” in object “LA”, attribute “lac” in object “UtranCell” may be mapped to attribute “locationAreaCode” in object “LA” (as is represented by arrow 810).

Another type of mapping is mapping one attribute in an object to multiple attributes in another object. In FIG. 8, object “UtranCell” includes the single attribute “outgoingGsmlsDaho[i]” that corresponds with attributes “outFddToGsmCellsDaho[i]” and “outFddToGsmCellsDahoPri[i]” in object “LCell”. Mapping a single attribute with multiple attributes causes problems as the attributes cannot be directly mapped and compared. The attribute values in the single attribute need to be mapped to attribute values in the multiple attributes. The following mapping rules define that mapping:

```
<SeqMap top=“outgoingGsmIsDaho” bottom=“outFddToGsmCellsDaho”
  topKey=“refCell” bottomKey=“.” dnTypeKey=“GsmExtCell”>
  <FieldMap top=“refCell” dnType=“GsmExtCell”/>
<FieldMap top=“relationType”
    bottom=“byIndex:outFddToGsmCellsDahoPri”>
    <ValueMap top=“isDaho1” bottom=“1”/>
    <ValueMap top=“isDaho2” bottom=“2”/>
    <ValueMap top=“isDaho3” bottom=“3”/>
  </FieldMap>
</SeqMap>.
```

Rule <FieldMap top=“refCell” dnType=“GsmExtCell”/> provides that the field “refCell” of ith structure in the sequence attribute “outgoingGsmIsDaho” of object “UtranCell” should match with the ith entry in the sequence attribute “outFddToGsmCellsDaho” of object “LCell” based on a DN mapping function “GsmExtCell”. Rule <FieldMap top=“relationType” bottom=“byIndex:outFddToGsmCellsDahoPri”> provides that the field “relationType” of ith structure in the sequence attribute “outgoingGsmIsDaho” of object “UtranCell” should match with the ith entry in the sequence attribute “outFddToGsmCellsDahoPri” of object “LCell” based on the value mapping rules defined below.

The values of the corresponding attributes may not be of the same type. Thus, there is a need for value mapping. For instance in FIG. 8, the value type of field “relationType” of object “UtranCell” is different from the value type of attribute “outFddToGsmCellsDahoPri” of object “LCell”. Rule <ValueMap top=“is Daho1” bottom=“1”/> says that for the ith position in the corresponding sequences the value “is Daho1” of field “relationType” should match with the value “1” of the attribute “outFddToGsmCellsDahoPri”.

In conclusion, processing network management data stored in network elements as described in the embodiments herein advantageously provides a simpler and more effective way of synchronizing data among the network elements.

We claim:

1. A method of synchronizing network management data among network elements of a telecommunication management network, the method comprising the steps of:
receiving a first data set from a first network element of the telecommunication management network;
receiving a second data set from a second network element of the telecommunication management network;
processing the first data set to identify a first object in the first data set;
processing the first object and the second data set based on mapping rules to identify a second object in the second data set associated with the first object in the first data set;
processing the first object and the second object based on the mapping rules to map the first object to the second object;
processing the first object and the second object as mapped to identify differences between the first object and the second object; and
generating information indicating the differences between the first object and the second object.

2. The method of claim 1 further comprising the step of:
processing the first object and the information indicating the differences to generate new object data;
generating commands based on the new object data to adjust the first object stored in the first network element; and
transmitting the commands to the first network element.

3. The method of claim 2 further comprising the step of:
generating a human-readable report based on the information indicating the differences between the first object and the second object.

4. The method of claim 1 further comprising the step of generating the mapping rules in extensible markup language (XML) or another declarative language.

5. The method of claim 4 wherein at least one of the mapping rules identifies the second object in the second data set associated with the first object in the first data set.

6. The method of claim 4 wherein at least one of the mapping rules defines direct mapping between an attribute of the first object and a corresponding attribute of the second object.

7. The method of claim 4 wherein:
if an attribute of the first object does not have a corresponding attribute in the second object, then at least one of the mapping rules defines how to locate a third object that includes an attribute that corresponds with the attribute of the first object.

8. The method of claim 4 wherein at least one of the mapping rules defines mapping between one attribute of the first object and multiple attributes of the second object.

9. The method of claim 4 wherein at least one of the mapping rules defines mapping between an attribute value of the first object and an attribute value of the second object, wherein the attribute values are of a different type.

10. A data synchronization system for a telecommunication management network, the data synchronization system comprising:
a mapping system that receives a first data set from a first network element of the telecommunication management network, receives a second data set from a second network element of the telecommunication management network, processes the first data set to identify a first object in the first data set, processes the first object and the second data set based on mapping rules to identify a second object in the second data set associated with the first object in the first data set, and processes the first object and the second object based on the mapping rules to map the first object to the second object; and
a comparison system that processes the first object and the second object as mapped to identify differences between the first object and the second object, and generates information indicating the differences between the first object and the second object.

11. The data synchronization system of claim 10 further comprising:
an alignment system that receives the information indicating the differences between the first object and the second object, and processes the first object and the information indicating the differences to generate new object data; and
a command system that receives the new object data, generates commands based on the new object data to adjust the first object stored in the first network element, and transmits the commands to the first network element.

12. The data synchronization system of claim 11 further comprising:
a reporting system that receives the information indicating the differences between the first object and the second object, and generates a human-readable report.

13. The data synchronization system of claim 10 wherein the mapping rules are written in extensible markup language (XML) or another declarative language.

14. The data synchronization system of claim 13 wherein:
at least one of the mapping rules identifies the second object in the second data set associated with the first object in the first data set;
at least one of the mapping rules defines direct mapping between an attribute of the first object and a corresponding attribute of the second object;
if an attribute of the first object does not have a corresponding attribute in the second object, then at least one of the mapping rules defines how to locate a third object that includes an attribute that corresponds with the attribute of the first object;
at least one of the mapping rules defines mapping between one attribute of the first object and multiple attributes of the second object; and
at least one of the mapping rules defines mapping between an attribute value of the first object and an attribute value of the second object, wherein the attribute values are of a different type.

15. A software product for synchronizing network management data among network elements of a telecommunication management network, the software product comprising:
mapping instructions when executed by a processing system that receive a first data set from a first network element of the telecommunication management network, receive a second data set from a second network element of the telecommunication management network, process the first data set to identify a first object in the first data set, process the first object and the second data set based on mapping rules to identify a second object in the second data set associated with the first object of the first data set, and process the first object and the second object based on the mapping rules to map the first object to the second object;
comparison instructions when executed by the processing system that process the first object and the second object as mapped to identify differences between the first object and the second object, and generate information indicating the differences between the first object and the second object; and
computer-readable media that stores the mapping instructions and the comparison instructions.

16. The software product of claim 15 further comprising:
alignment instructions when executed by the processing system that receive the information indicating the differences between the first object and the second object, and process the first object and the information indicating the differences to generate new object data; and
command instructions when executed by the processing system that receive the new object data, generate commands based on the new object data to adjust the first object stored in the first network element, and transmit the commands to the first network element.

17. The software product of claim 16 further comprising:
reporting instructions when executed by the processing system that receive the information indicating the differences between the first object and the second object, and generate a human-readable report.

18. The software product of claim 15 wherein the mapping rules are written in extensible markup language (XML) or another declarative language.

19. The software product of claim 15 wherein the mapping instructions and the comparison instructions are written in extensible stylesheet language transformations (XSLT).

20. The software product of claim 15 wherein:
at least one of the mapping rules identifies the second object in the second data set associated with the first object in the first data set;
at least one of the mapping rules defines direct mapping between an attribute of the first object and a corresponding attribute of the second object;
if an attribute of the first object does not have a corresponding attribute in the second object, then at least one of the mapping rules defines how to locate a third object that includes an attribute that corresponds with the attribute of the first object;
at least one of the mapping rules defines mapping between one attribute of the first object and multiple attributes of the second object; and
at least one of the mapping rules defines mapping between an attribute value of the first object and an attribute value of the second object, wherein the attribute values are of a different type.
